(19) United States
(12) Patent Application Publication
(10) Pub. No.: US 2010/0005003 A1
(43) Pub. Date: Jan. 7, 2010

(54) Automated dry cleaning assembly system

(76) Inventors: Tony L. Cassaday, Rindge, NH (US); William T. Epperson, Little Rock, AR (US); Kevin J. Rowell, Maumelle, AR (US)

Correspondence Address: LAMBERT & ASSOCIATES, P.L.L.C., 92 STATE STREET, BOSTON, MA, 02109-2004, US

(21) Appl. No.: 12/460,785

(22) Filed: Jul. 24, 2009

Related U.S. Application Data
(63) Continuation-in-part of application No. 11/801,728, filed on May 10, 2007, now abandoned.
(60) Provisional application No. 60/799,518, filed on May 11, 2006.

(51) Int. Cl. G06Q 10/00; D06F 95/00; G06K 7/10

(52) U.S. Cl. 705/23; 705/28; 705/29; 235/462.01

(57) ABSTRACT

An automated assembly conveyor method and apparatus for dry-cleaners, wherein the system is disposed to recognize, associate, and consolidate garments in customer transactions by reading garment identification tags located within each item. The system further includes an optional point-of-sale system and mark-in station to facilitate the intake of items from a customer to ensure each item is input into a database.

### CROSS REFERENCE TO RELATED APPLICATION

This application is a continuation-in-part, which claims the benefit of and takes priority from pending U.S. application Ser. No. 11/801,728 filed on May 10, 2007, which in turn claims the benefit of and takes priority from U.S. Application No. 60/799,518 filed on May 11, 2006, now expired.

### BACKGROUND OF THE INVENTION

1. Field of the Invention

This invention relates generally to automated systems for assembling and sorting items, and more particularly to an automated sorting system preferably for use in the dry cleaning industry, wherein the system is disposed to interpret and utilize various tags and labels in the classification and sorting of the items.

2. Description of the Related Art

A compelling burden in the dry-cleaning industry is to classify and account for the many garments and products moving through the cleaning apparatus. Many dry-cleaning establishments use antiquated, non-computerized, manual techniques for sorting products. Older sorting routines can be extremely cumbersome and time consuming, besides being error prone. Typically, to keep track of orders, dry-cleaning establishments may divide garments or groups of customer garments into unique customer orders.

After products are cleaned, an assembly process follows. During assembly, cleaned garments are gathered and returned to the customer. The process requires the proper evaluation of order numbers for each garment.

A basic function of inventory control is the counting of incoming and outgoing materials, and the keeping of a running total. In some situations, the identity of specific articles must be monitored, making inventory control somewhat more complicated. Automation in marking, sensing and routing can present enormous cost savings over manual operations for such establishments. Although the user is always subject to equipment failure, every step at which manual functioning and decision making can be eliminated likewise avoids time loss, errors, and various losses associated with human operation.

An inventory control system particularly adapted for a dry-cleaning store has many needs in common with the usual merchandise distribution warehouse system. Furthermore, the relatively low cost of individual transactions and cleaning operations aggravates the need to cut costs. In general, the possible revenue to be gained by processing a single article is quite small in comparison to the possible dissatisfaction which could be generated with consumers by even small percentage losses of articles and the like.

The usefulness of automated apparatus for information and process control has further benefits. The optimization of dry-cleaning store efficiency requires that garments or products be divided into batches of similar characteristics that may be processed as units. For example, all articles of a given type of fabric may be best processed under certain conditions involving specific cleaning fluids, particular operating temperatures and timing cycles, and the like. The operator (or his supplier) can clean the largest number of articles at the least expense by most efficiently allocating his machines and materials to reflect the particular mix of supplies being presented by the customers.

In connection with laundry systems, a common practice has been to apply a unique tag to a unit of laundry. While such tags may have alpha-numeric markings that are machine readable, it is preferable that the tags also be readable by the human operators. Once prepared, the identifying tags are coupled to the product or article of clothing. A different or more complicated indicia may also be attached to a hanger or the like, upon which the article of clothing is suspended. In any event, some form of code is needed for each article.

Bar codes applied to various forms of identification labels are increasingly popular for identifying products or packages. In typical retail establishments, dealing with diverse goods and merchandise, each product has a unique bar code number that identifies the product, its price, the manufacturer or source, and other commercial data. Bar codes are quickly read by laser scanning and then decoded by suitable bar code reader apparatus. Various computer programs are available for utilizing decoded indicia obtained from bar codes in a database. Images may also be captured during the scanning process. However, once an image is captured, it must be processed to identify and decode a variety of encoded indicia, including bar codes, two-dimensional dense codes, and alphanumeric characters.

Many drycleaners attach bar coded, machine readable identification labels to each garment. These bar coded tags may be permanently attached to the garment (using a “heat seal” type of tag), or the bar code may be printed on a “one time use” tag material and attached to the garment for each cleaning cycle.

While bar coded labels can be used in dry-cleaning establishments, the washing process to which items are subjected may degrade the printing, making it difficult and error prone to read and decipher. In some cases, the damage or degradation may be extensive enough that no amount of rescanning will be able to recover the lost information. Typical dry cleaning labels or tags include relatively large, human readable characters corresponding to the bar code characters that are printed adjacent to the bar code. When the bar code is unreadable, the human readable text may be deciphered by a human attendant, and data may be manually entered into the associated computer database.

RF or RFID identification chips and paper ID tags also find application in the retail dry-cleaning industry. Each identification method requires unique scanning techniques and hardware to read and interpret the encoded information. Radio Frequency (RF) chips are utilized by a small group of very large drycleaners to uniquely identify garments.

Most drycleaners continue to utilize disposable, single usage paper identification tags that are temporarily attached to each garment. These paper ID tags contain the alphanumeric identification information necessary to uniquely identify and relate each garment to its respective customer order.

Another data input option is the manual entry of the identification tag information by a human operator. This input method is old and time consuming, but a modern scanning system must offer this form of input as a substitute where the scanning system is unable to electronically read the information tag or process the scanned information derived therefrom. Where the scanning apparatus fails to function, data must be manually entered via a computer keyboard. As a practical matter modern scanning systems must provide for manual scanning as the last line of defense against unreadable tags to prevent the Loss or mismatching of articles or garments.

### SUMMARY OF THE INVENTION

The instant invention, as described further herein, imparts a novel automated system for assembling and sorting items for use in the dry cleaning industry, wherein the system is disposed to recognize, associate and consolidate each dry-cleaned or laundered item for customer transactions by interpreting an identification tag attached to each item.

The invention interfaces to a “Point of Sale” system when available.

Identification tags are read by a scanning apparatus whose construction may vary depending upon they type of garment tagging system utilized by a given retail drycleaner. The invention reads through Optical Character Recognition (OCR) scanning, Bar Code scanning, or Radio Frequency (RF) means.

The system easily assembles a large inventory of individual garments into unique groupings (sometimes referred to as “Orders”, or “Tickets”, or “Invoices”) by customer. The system efficiently manages the processes of scanning, identifying, and grouping individual garments into smaller groupings (called “Orders”) for each customer. Each different “group” has at least one garment, and may include a large number of garments. The system also maintains a running record of the inventory of customer Orders that are not completed and remain on the assembly conveyor for various reasons and may require special attention to resolve.

One component of the invention is a customized attribute recognition program (such as an OCR recognition program, or a bar code recognition program) which interprets the scanned garment identification tag(s) information and in turn generates an internal binary text string from this alphanumeric tag information. These internal binary text strings are then programmatically compared to various text strings stored in an inventory management system (e.g., existing point-of-sale system) database, or are compared to various text strings stored in an internal lookup table unique to the invention where an inventory management system is not present. This comparison process programmatically determines the identity of the customer “owner” of each garment. Also, this comparison process determines the identification number (also referred to as the customer Order Number) assigned to the “grouping” of garments in which this garment is assigned. This Order Number information, as well as the garment identification tag data is required for the re-assembly process. Once the Order Number associated with this garment identification tag is identified, the invention assigns a specific numbered location on a conveyor where all subsequent garments for this Order Number will also be grouped. As each garment is scanned, the invention identifies the Order Number associated with this garment and the invention automatically rotates a conveyor to the assigned location where all garments for the same Order Number will be consolidated. Once all garments for a specific Order Number have been consolidated, then the system notifies the operator that all expected garments for this Order Number have been processed and the “group” of garments for this Order Number are now ready for removal from the conveyor to be routed to the next stage in the plant production process (which is normally the “bagging station”).

The invention communicates with a Point-of-Sale System in use at the dry-cleaning plant over a computer network (either LAN or WAN). The order and garment in formation is received by the invention and stored in a local lookup table for retrieval and comparison when required at a later time. This local lookup table allows the system to continue to operate for several hours in the event the computer network fails. The invention also provides information about the garment's assembly status and operator efficiency information to the Point-of-Sale system using the same computer network and shared files. In the event that the Point-of-Sale system ceases to provide the information required to assemble the garments, the operator is notified by a flashing icon on the computer interface screen.

Thus a basic object is to provide a computerized system for automatically sorting, marking, and assembling various objects or items or groups of such items.

A related object is to provide an automatic reading and sorting system of the character described that is ideal for dry-cleaning establishments.

A fundamental object is to automate the process of manually matching dry-cleaning garment tags with the correct customers and/or the correct order numbers.

It is also an object of the invention to provide an automated inventory control system that addresses the particular needs of a retail dry-cleaning establishment.

A further object of the invention is to use scanned bar code labels in a dry-cleaning establishment.

Another object of the invention is to provide an inventory tracking and management apparatus in which identification codes for articles such as garments or orders of several garments can be acquired automatically for managing inventory.

Yet another important object of the invention is to provide an inventory scanning and tracking system that can use RF/RFID technology, bar code scanning technology, OCR technology, combined with the ability to accept and process manual data entry.

Another object of our invention is to employ a bar code scanner to electronically interpret identifying information encoded in a bar code associated with a tag applied to incoming goods to be laundered, and to use this garment identification information to complete the assembly process for each garment.

Another object is to provide a scanning system of the character described that utilizes OCR imaging scanner technology and an associated OCR interpretation program customized for the specific ID tag utilized by the drycleaner.

It is a further object of the invention to provide an inventory tracking and management system which employs RF encoding.

It is also an object to analyze optical character recognition (OCR) data in addition to bar code reading and scanning.

A related object of the present invention is to supplement bar codes with human readable characters or indicia.

A still further object is to verify, interpret, route and store decoded data associated with garment identification in a dry-cleaning establishment.

An object of the invention is to communicate with a Point-of-Sale System in use at the dry-cleaning plant over a computer network (either LAN or WAN). It is a feature of the invention that order and garment information is received by the invention and stored in a local lookup table for retrieval and comparison when required at a later time.

Another object of the instant invention is to provide a mark-in system that is disposed to interface with a point-of-sale system thereby enabling an individual to input items received from customers into the system.

Another object of the instant invention is to provide a mark-in system that is disposed to enable operation of the system without requiring a point-of-sale system for marking-in items.

Another object of the instant invention is to provide an operator with a plurality of voice prompts and confirmations relating to items recently input into the system.

Another object of the instant invention is to provide a system that is disposed to interface with a plurality of printers, wherein each printer references a unique delivery route or store.

Another object of the instant invention is to provide a system that is disposed to provide an operator the quantity of items that are scheduled for sorting and assembly over a pre-determined time period.

Another object of the instant invention is to provide a system, wherein the system is disposed to mark-in multiple items as a single order and then separate the order into smaller sub-orders during assembly.

There has thus been outlined, rather broadly, the more important features of the automated system for assembling and sorting items, in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1A illustrates a diagrammatic perspective view of the automated system for assembling and sorting items in the dry cleaning industry.

FIG. 1B illustrates an exploded perspective view of the loading shroud and conveyor slots utilized to retain a plurality of items.

FIG. 2 illustrates a block diagram of the system.

FIG. 3 illustrates a block diagram of the conveyor control component of the system.

FIG. 4 illustrates a diagrammatic top view of the conveyor apparatus and operator station area of the system.

FIG. 5 illustrates a fragmentary, isometric view of the OCR Scanner station.

FIGS. 6-8 illustrate diagrammatic views of various sample identification tags utilized by the system during the assembly and sorting of items.

FIGS. 9-15 illustrate multiple flow diagrams of the computer software disposed for scanning garment identification tag information and for subsequent processing.

FIG. 16 illustrates a flow diagram of the software disposed for interfacing to a Point of Sale system.

FIG. 17 illustrates a flow diagram of the software disposed for interfacing to a Mark-In system.

FIG. 18 illustrates a flow diagram for providing an operator the quantity of items that are scheduled for sorting and assembly over a pre-determined time period.

### DETAILED DESCRIPTION OF THE PREFERRED EMBODIMENT

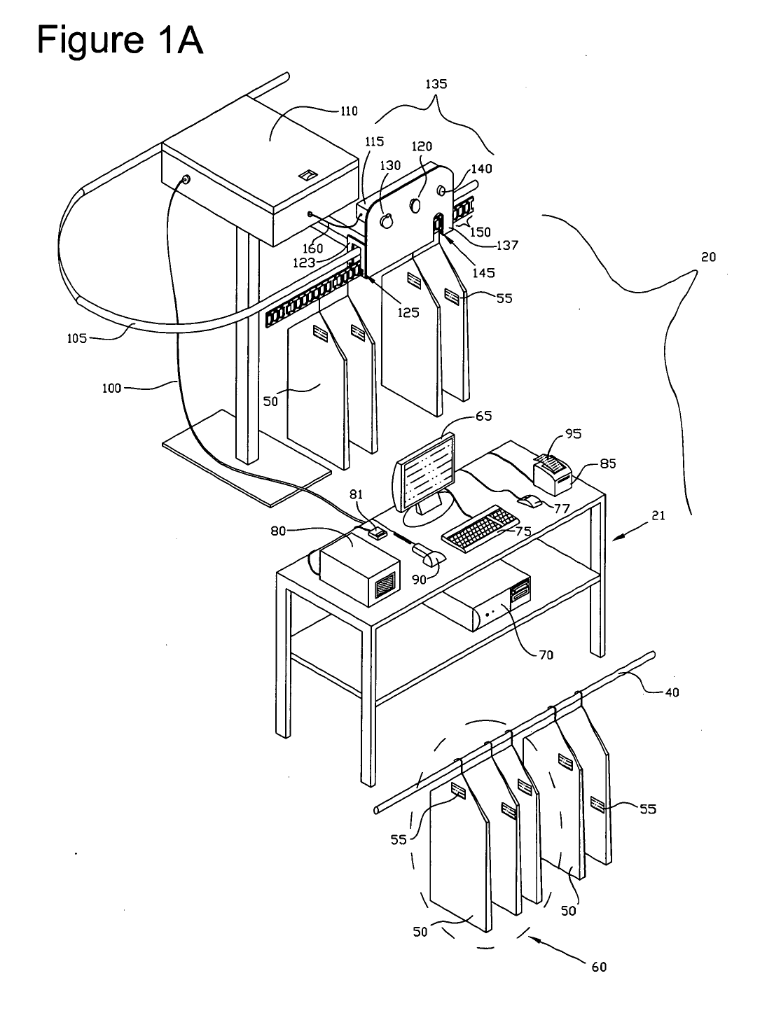

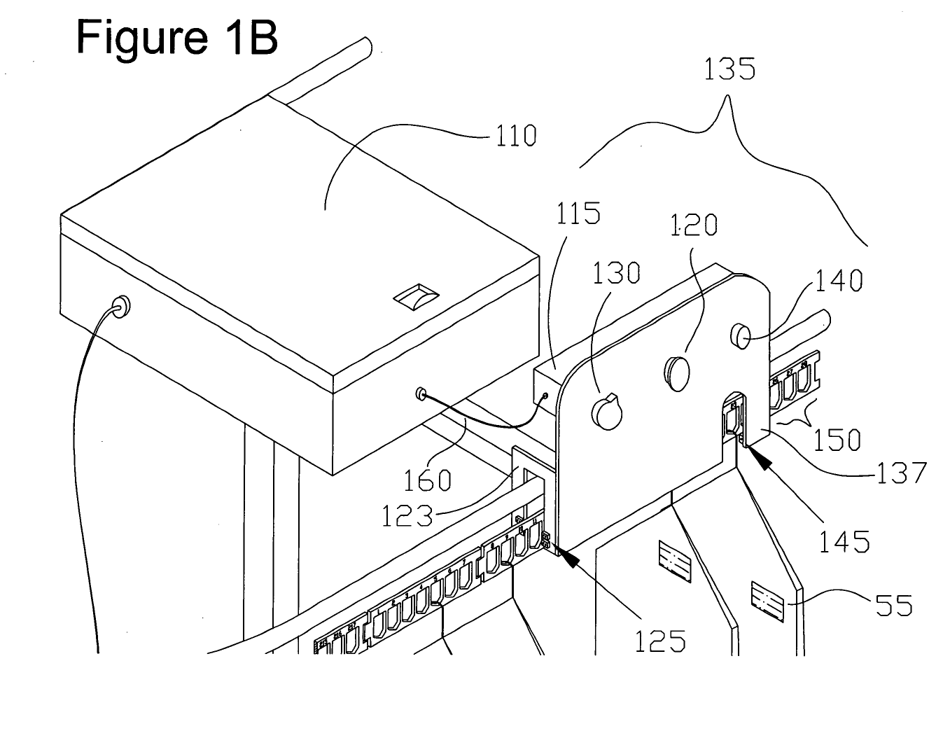

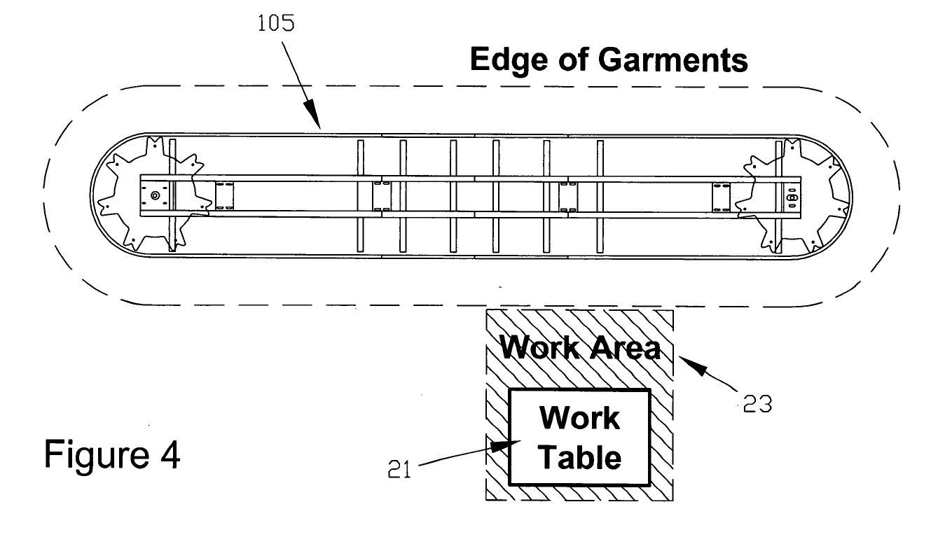

FIG. 1A illustrates the instant invention 20 consisting of an automated system for assembling and sorting items, preferably for use in the dry cleaning industry. In the preferred embodiment, the system is disposed to handle and inventory items being dry-cleaned. As used herein, the term “item” designates not only garments, but other products including but not limited to rugs, bedding items, pillow casings, and blankets, along with a variety of other things which can be dry-cleaned. During operation of the system 20, an operator (not shown) may stand near a work table 21 (see FIG. 4) preferably located within a work area 23 of a dry-cleaning establishment or other similar business venture.

Initially, a customer (not shown) provides a plurality of items 50 to an operator, wherein the items 50 for a given transaction are received through a “mark-in process”. In the preferred embodiment, a plurality of items 50 belonging to a given customer transaction may be assembled as a group 60 and subsequently identified; the group 60 may also be referenced as a customer order. In one embodiment, if a customer brings in separate items over multiple visits, then a separate transaction is observed, and a separate customer order or group is formed for each corresponding visit. Once the group 60 is identified, the individual items 50 of the group 60 become commingled with other items 50 belonging to different customers that have been similarly associated with separate customer orders 60.

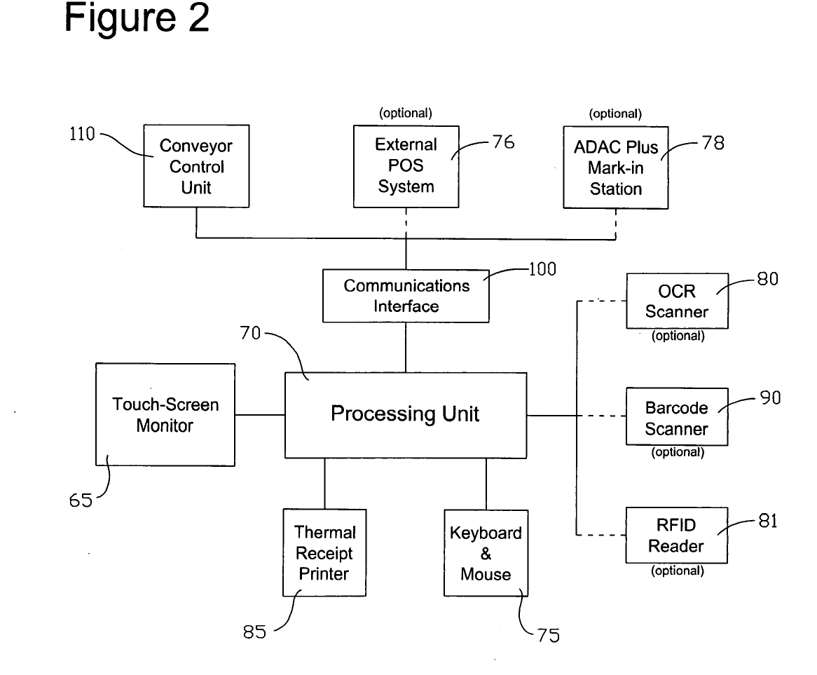

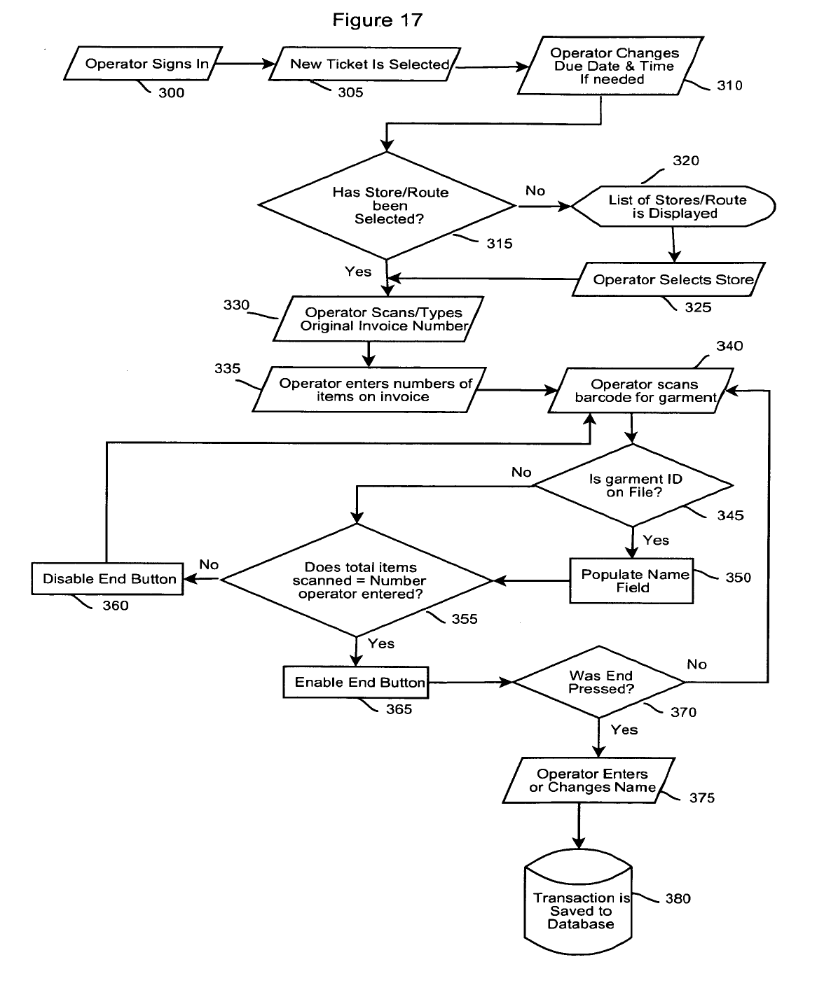

Once cleaning is complete, the system 20 aids the operator in reassembling the required items 50 with the original group 60 that was created when the customer initially provided the items 50 for cleaning. In the preferred embodiment, the operator selects one garment 50 from a pre-assembly holding rail 40 and scans a garment identification (“ID”) tag 55 attached to the item 50, using either an Optical Character Recognition (“OCR”) scanner 80 or a bar code scanner 90; in an alternate embodiment, the operator may utilize a radio frequency (“RF”)/radio frequency identification (“RFID”) receiver 81. In one alternate embodiment, if the garment ID tag 55 is unable to be interpreted through the use of one of the above-mentioned methods, the information contained within the ID tag 55 may be manually entered by an operator into the system 20. Preferably the information is entered into a database processor 70 through either a computer keyboard 75, a mouse 77, or via a touch screen monitor 65. In one alternate embodiment, the information may be obtained electronically through an external point of sale (“POS”) system 76 (see 76 (see FIG. 2); in yet another alternate embodiment, an operator may enter the information through a mark-in station 78 (see FIG. 2 and FIG. 17).

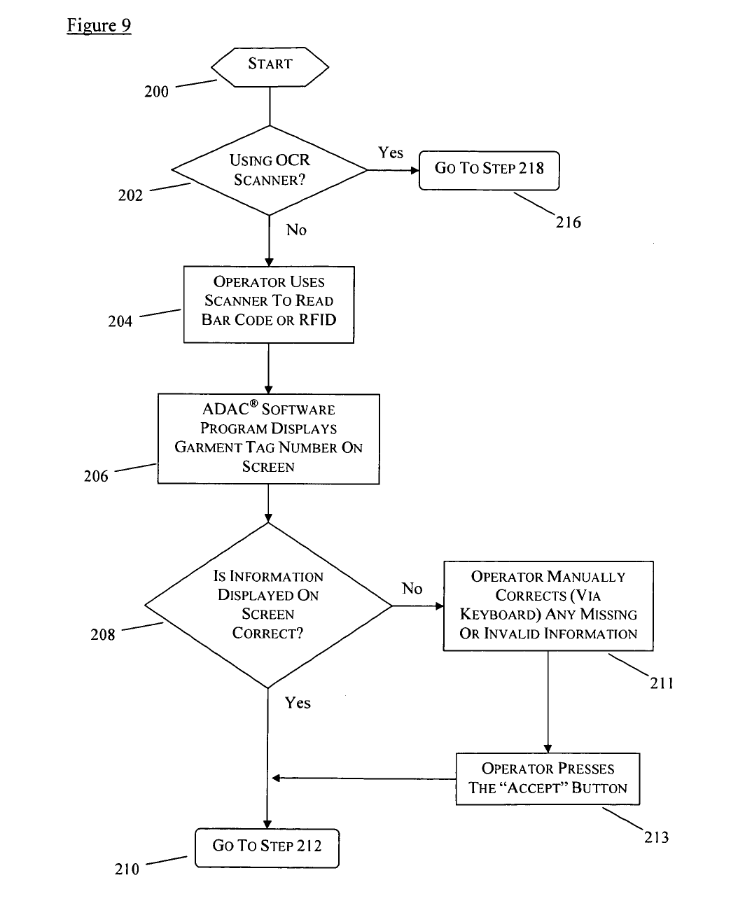

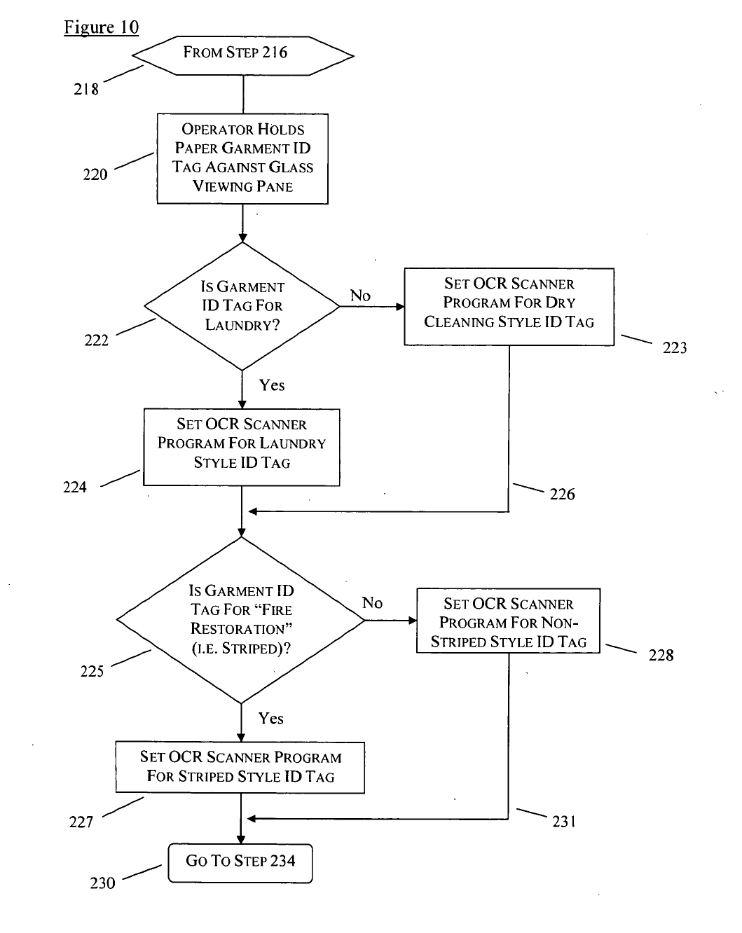

Once information from the ID tag 55 is received by the custom software program (see FIGS. 9-15) running in the data processor 70, the system 20 programmatically assigns a specific conveyor slot 150 number on an assembly conveyor 105 to be reserved for all items 50 associated with the same group 60. The system 20 then sends an electronic command from the data processor 70 via a communications interface 100 to a conveyor control unit 110. The electronic command enables the assembly conveyor 105 to automatically rotate until the reserved slot 150 location on the conveyor is positioned to allow for hanging of the items on a loading shroud assembly 135. Preferably, the operator will hang the item 50 on this specified slot 150; the system automatically detects that the operator has hung the item 50 on the slot 150. Ultimately, this process is repeated with the next item 50 to be assembled and sorted by the system 20. Upon scanning the last item 50 of a specific group 60, a receipt is automatically produced via a receipt printer 85 for the Completed Order, listing specific information related to each item 50 in the group 60.

Following rotation of the conveyor 105 to reach the assigned slot 150 for a specific customer order 60 such that the slot 150 is positioned at the loading shroud assembly 135, a light 140 illuminates over the loading shroud assembly 135 serving as a visual confirmation to the operator that the customer order 60 is complete and ready to be removed from the assembly conveyor 105. Furthermore, as described below, the system may incorporate an audible voice prompt informing an operator that the order is complete, while simultaneously displaying the same message on the touch screen monitor. Additionally, a sensor 145 is located on the loading shroud assembly 135, wherein the sensor 145 sends an electronic signal via a connecting cable 160 to the conveyor control unit 110 to acknowledge that the customer order 60 has been removed from the conveyor 105. The connecting cable 160 passes through an enclosure 115 to the conveyor control unit 110. Once the garments 50 for the customer order 60 are removed from the assembly conveyor 105, this conveyor slot 150 is now available to be re-assigned for another customer order. Moreover, the system 20 may utilize a conveyor slot bracket assembly 123 to ensure substantially accurate positioning of the conveyor 105 with respect to the loading shroud 135. The bracket assembly 123 further includes a plurality of beam sensors 125, wherein the beam sensors 125 are preferably oriented towards the slots 150 of the conveyor 105. Therefore, when one slot 150 passes through and interrupts the beam sensors 125, a digital pattern is created and decoded by the conveyor control unit 110 to ascertain the current position of the conveyor 105. The conveyor slots 150 may be programmatically assigned and tracked by the custom software to be described hereinafter (see FIGS. 9-15). Preferred conveyors with the slot function are available from Railex Corporation, 89-02 Atlantic Ave, Queens, N.Y. 11416.

FIG. 1B illustrates the loading shroud assembly 135 wherein the loading shroud assembly 135 further includes a loading shroud 137 along with an emergency stop switch 120, a conveyor manual jog switch 130 and an order complete light 140 along with the bracket assembly 123. The loading shroud assembly 135 prevents the operator from placing an item 50 on any slot 150 but the desired one. The emergency stop switch 120 cuts all electrical power to the system 20 when pushed in and the conveyor manual jog switch 130 is used in the rare case the operator needs to manually move the conveyor 105 to a particular slot 150. The “order complete” light 140 indicates to the operator when an order is complete and needs to be removed from the conveyor.

FIG. 2 illustrates a block diagram of the system 20 along with the POS system 76 and Mark-In station 78.

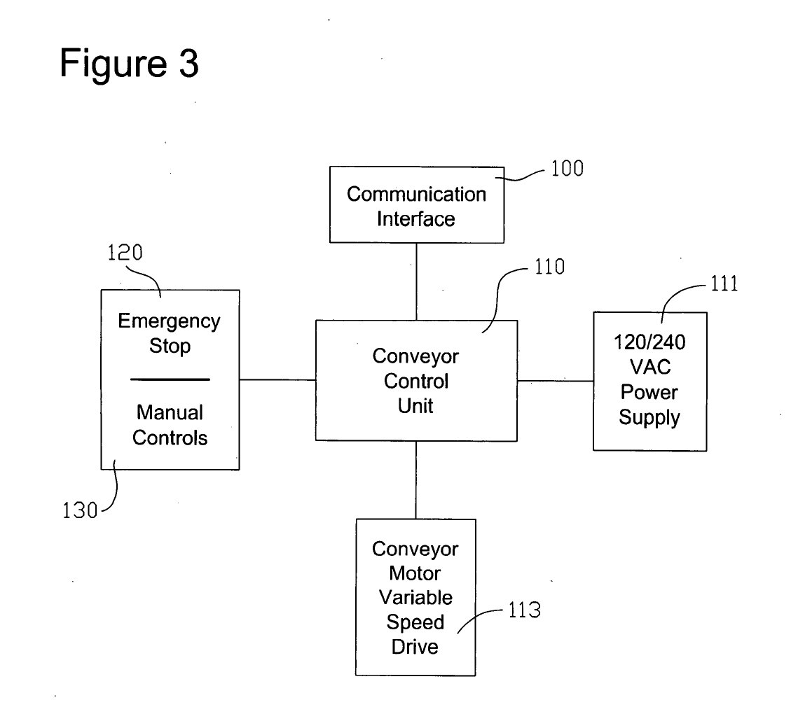

FIG. 3 illustrates a block diagram of the conveyor control unit 110, wherein power is supplied to the control unit 110 via a power source 111. Also, the speed of the conveyor 105 may be varied through a speed drive 113.

One component of the system 20 is a customized attribute recognition program (such as an OCR recognition program, or a bar code recognition program) which interprets the information on the ID tag 55, and in turn generates an internal binary text string from this alphanumeric tag information. These internal binary text strings are then programmatically compared to various text strings stored in an inventory management system (e.g., existing point-of-sale system) database, or are compared to various text strings stored in an internal lookup table unique to the system wherein an inventory management system is not present. This comparison process programmatically determines the identity of the customer “owner” of each garment. Also, this comparison process determines the identification number (also referred to as the customer Order Number) assigned to the “grouping” of garments in which this garment is assigned. This order number information, as well as the garment identification tag data is required for the re-assembly process. Once the order number associated with this garment identification tag is identified, the invention assigns a specific numbered location on a conveyor where all subsequent garments for this order number will also be grouped. As each garment is scanned, the system 20 identifies the order number 60 associated with this item and the system automatically rotates the conveyor 105 to the assigned location where all items 50 for the same order number 60 will be consolidated. Once all items 50 for a specific order number 60 have been consolidated, then the system 20 will notify the operator that all expected items 50 for this order number 60 have been processed and the “group” of garments for this order number 60 are now ready for removal from the conveyor 105 to be routed to the next stage in the plant production process (which is normally the “bagging station”).

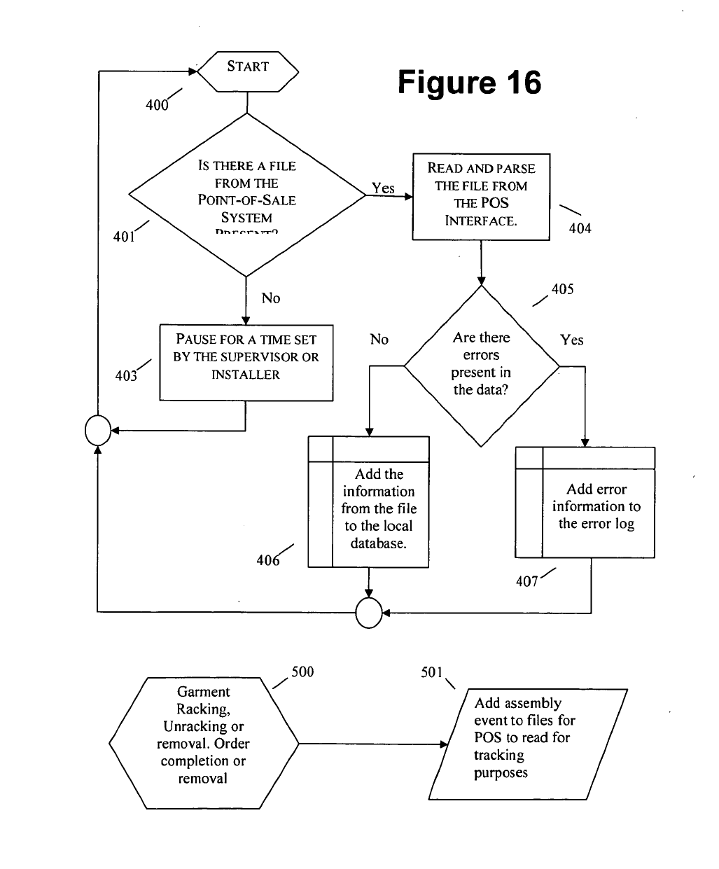

As described above, the system 20 may communicate with an external Point-of-Sale system 76 via several commands issued using shared files over a computer network (either LAN or WAN) (see FIG. 16). The Point-of-Sale System creates or appends to files with garment and order information. The order and garment information is read by the invention and stored in a local lookup table for retrieval and comparison when needed at a later time. This local lookup table allows the system to continue to operate for several hours in the event the computer network fails. The invention also provides information about the garment's assembly status and operator efficiency information to the Point-of-Sale system using the same computer network and shared files. Multiple files are used for different commands and information.

In the event that the Point-of-Sale system ceases to provide the information required to assemble the garments, the operator is notified by a flashing icon on the computer interface screen.

The series of files and the content was developed specifically for the invention by the inventors. This flexible format allows the invention to interface with multiple Point-of-Sale systems without modification to the original source code of the program. In the event that the data in the files are incorrectly formed or corrupted, the invention creates a log of the incorrect. This log is available to the operator for troubleshooting purposes

Moreover, the system 20 can operate with or without the presence of an inventory management control system (commonly referred to as a point-of-sale POS system). In the case where a POS system 76 and mark-in station 78 are not present, then the total number of garments 50 associated with a customer Order 60 would need to be present on the garment ID tag 55.

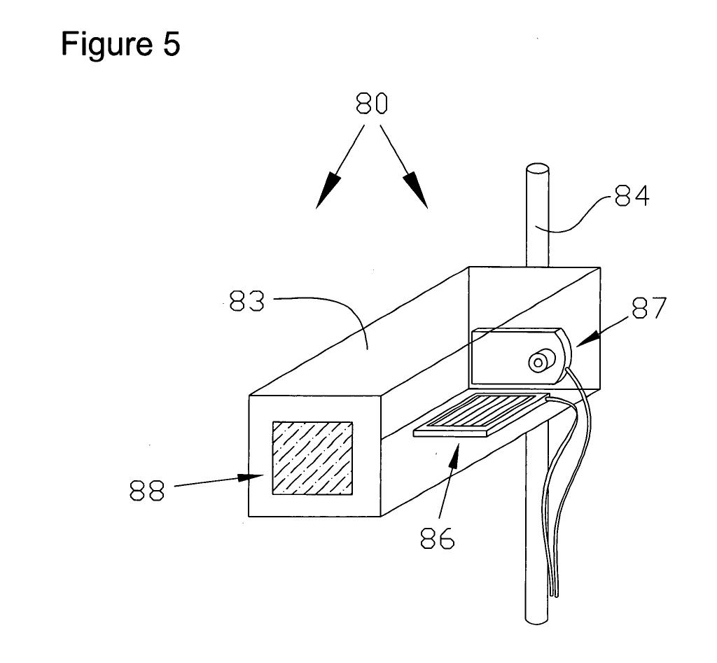

FIG. 5 illustrates the OCR scanner 80, wherein the OCR scanner includes a metal housing 83 secured to a support 84. The scanner 80 further includes a light 86 located within a housing 83, wherein the light 86 is disposed between an OCR scanner element 87 and a glass viewing pane 88. As previously discussed, other optically scannable indicia can be used, as well as electrically encoded scannable indicia such as RF chips or magnetically encoded tags. Alternatively, a less sophisticated encoding is possible, such as coding shown alphanumerically and entered by keystrokes via the computer keyboard 75.

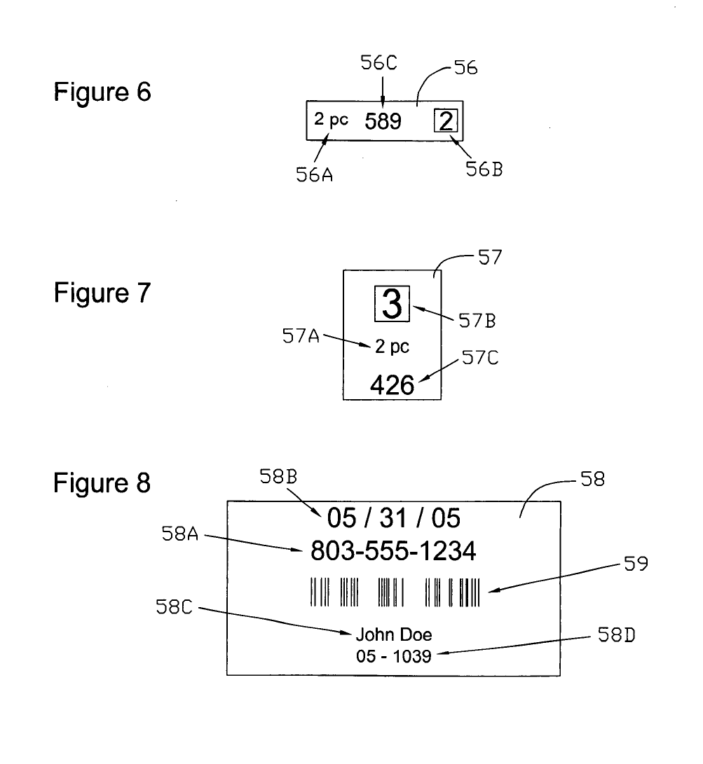

FIGS. 6-8 illustrate representative ID tags 55; there are industry “generic” tags that can be ordered from several dry-cleaning supply companies, and there are “customized” paper tags that are designed and printed to the drycleaner's specifications. All of these tags 55 (generic or custom) are available in ten standard colors. Some drycleaners use the color of the tag to indicate which day of the week the clothes are promised to be ready for the customer to pick up. Some use colored tags to indicate which store the clothes originated from and where they will be returned; all of the sample tags in shown in FIGS. 6-8 may be produced in up to ten colors or more.

The indicia on each tag 55 are interpreted by the OCR scanner 80 and are interpreted by the software program discussed hereinafter (see FIGS. 9-15). The indicia information is displayed on the computer screen for the operator to view and confirm before processing the garment. Therefore it is the responsibility of the operator to verify that the indicia are accurate. There is not an example of a striped tag, but any tag design can contain stripes, stars, diamonds, and other special characters to be used as additional identification marks, such as to distinguish “delivery route” Orders from “in store” orders, etc. The specific meaning varies from one drycleaner to another regarding the use of stripes, stars, diamonds, etc, as identifying marks on the tags.

FIG. 6 illustrates a representative laundry tag 56 possessing a piece designation 56A that indicates that the order has two pieces for laundering, (i.e., “2pc.”). Both garments in this order 60 will have the same information printed on a paper tag 56. In this embodiment, an Identification Control Number 56C or customer order number is shown as “589.” A “promise number” 56B (i.e., “2”) is located in a box that indicates the day of the week that the order is “promised,” which is determined by a formula wherein 1=Monday, 2=Tuesday etc.

FIG. 7 illustrates a typical dry-cleaning tag 57 with a piece identification 57A (i.e., 2 pieces in this order), a boxed “promise number” 57B (i.e., “3”) indicating that the completed order has been promised for Wednesday, and an identification control number or order number 57C (i.e., “426).

FIG. 8 illustrates a more sophisticated custom dry cleaning tag 58 with a barcode 59 containing a customer phone number 58A (i.e., “803-555-1234”), an entry date 58B (i.e., “05/31/05”), and a customer name 58C (i.e., “John Doe”); the number 58D (i.e., “05-1039”) is a numerical representation of what is contained in the barcode 59 above it.

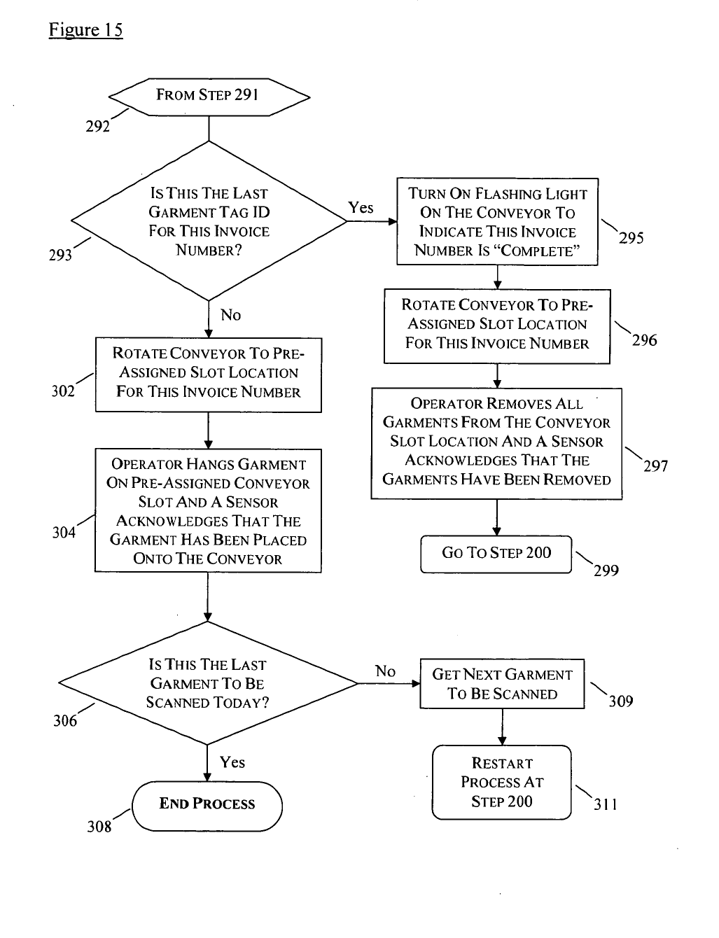

FIG. 9 illustrates the commencement of the software program. The software program commences at step 200 (FIG. 9). Step 202 determines if OCR scanning is being used, and if not, in step 204 the operator must use the scanner to read the bar code (i.e., such as barcode 59 in FIG. 8) or RF ID. The garment tag number is displayed on screen 65 (FIG. 1) in step 206. A decision is made in step 208 whether or not the screen information is correct. If so, the program jumps at 210 to step 212 in FIG. 14. If not, the operator manually enters correct data in step 211, entering missing information and correcting errors. When correct, the operator presses an “accept” button in step 213, which is followed by steps 210 (FIG. 9) and step 212 (FIG. 14), to be explained hereinafter.

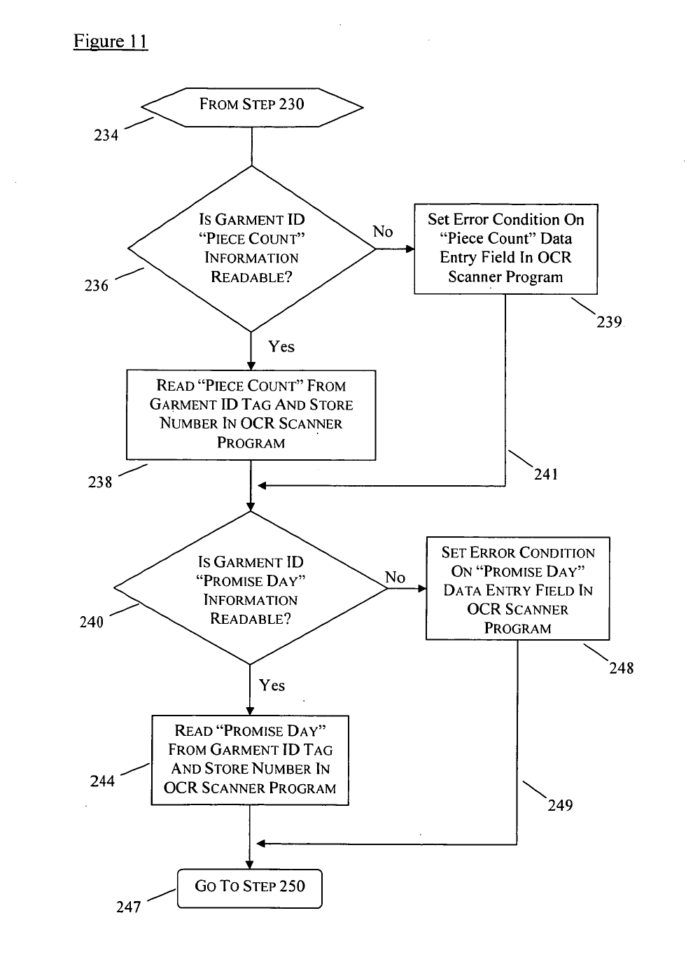

If step 202 (FIG. 9) determines that OCR reading is used, step 216 (FIG. 9) is followed by step 218 (FIG. 10). In step 220 (FIG. 10) the operator holds the ID tag against the glass viewing pane 88 (FIG. 5) of the OCR scanner. Step 222 determines if the garment ID tag is for laundry or dry-cleaning. If it is a laundry tag, the OCR is set for reading laundry style tags in step 224 and step 225 follows. If OCR determination step 222 determines that a dry cleaning tag exists, the OCR step 223 sets the scanner program for dry-cleaning and proceeds to step 225 as indicated by line 226.

Step 225 (FIG. 10) determines if the ID tag indicates fire restoration, i.e., the tag is striped, and if so, step 227 follows and the OCR scanner is set for striped style tags and proceeds to step 230. If not, a striped tag, step 228 sets the OCR scanner program for non-striped tags, and step 230 follows, as indicated by line 231.

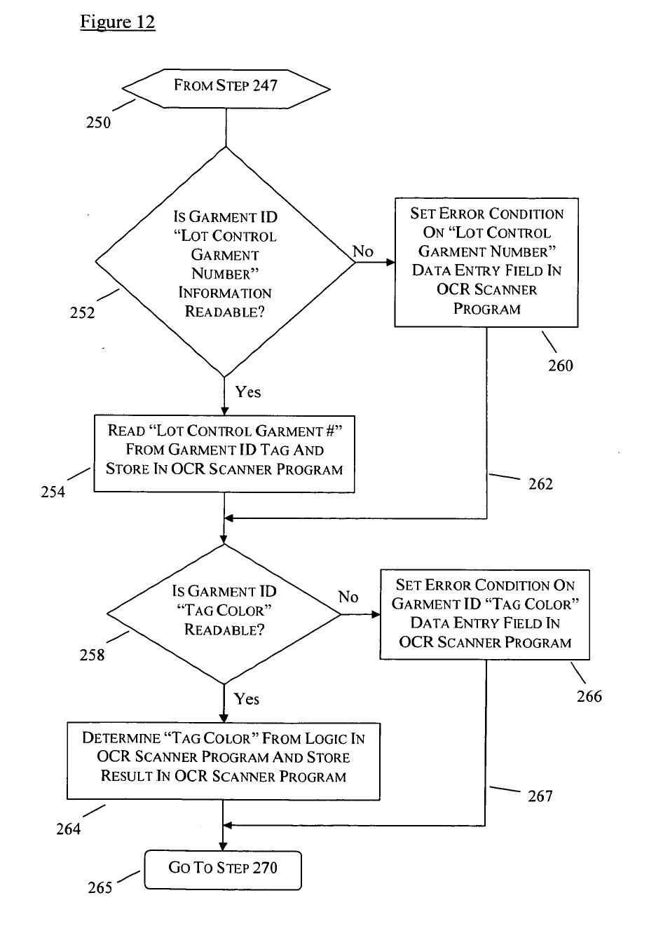

Step 230 (FIG. 10) connects to step 234 in FIG. 11 which is followed by step 236 that determines if the garment ID “piece count” is readable. If readable, the “piece count” is read and stored in the OCR scanner program in step 238. If the “piece count” is not readable in step 236, step 239 sets an error condition on the piece count data entry field in the OCR scanner program, and step 240 follows as indicated by line 241.

Step 240 (FIG. 11) determines if the “promised day” delivery date information is available. If so, step 244 reads the “promised date” from the garment ID tag and stored that date in the program, exiting to step 247. If not, step 248 sets an error condition for the “promised day” information in the data entry field of the OCR scanning program. Step 248 is followed by step 247 as indicated by line 249.

Step 247 (FIG. 11) connects with step 250 of FIG. 12, which is followed by step 252 that determines if the “lot control garment number” is readable. If it is, step 254 reads the “lot control garment” number and proceeds to step 258. If not, step 260 sets an error condition marker for the lot control garment number in the data entry field of the OCR scanner program, and continues to step 258 as indicated by line 262.

Step 258 (FIG. 12) determines if the garment ID “tag color” is readable. If so, step 264 determines the “tag color” in OCR logic, and stores the result in the OCR scanner program, then running to step 265. If “tag color” is not readable in step 258, step 266 sets an error condition for tag color in the data entry field of the OCR scanner program, and proceeds as indicated by line 267 to step 265.

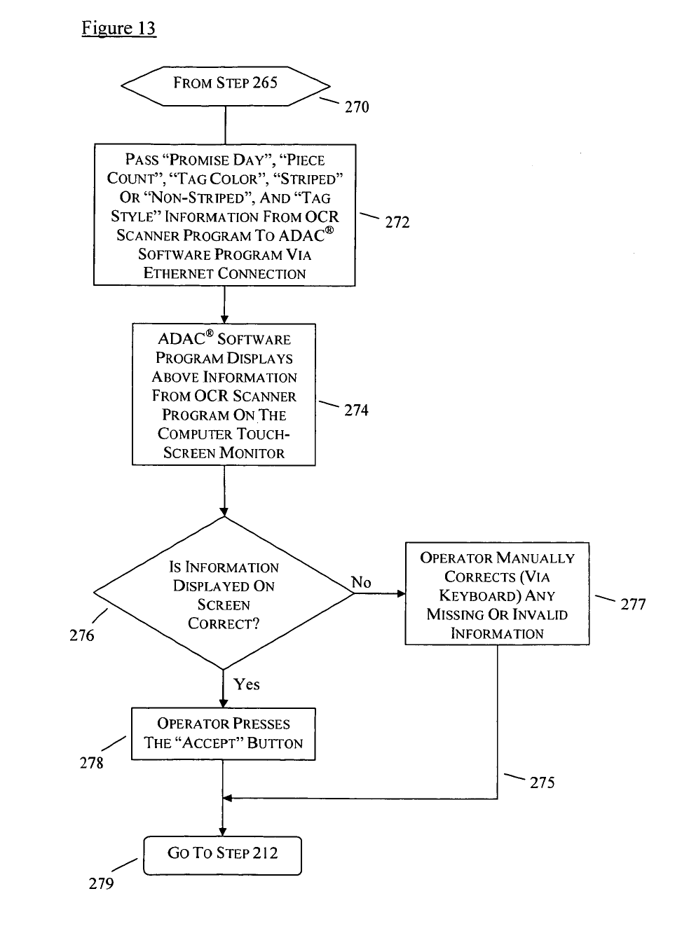

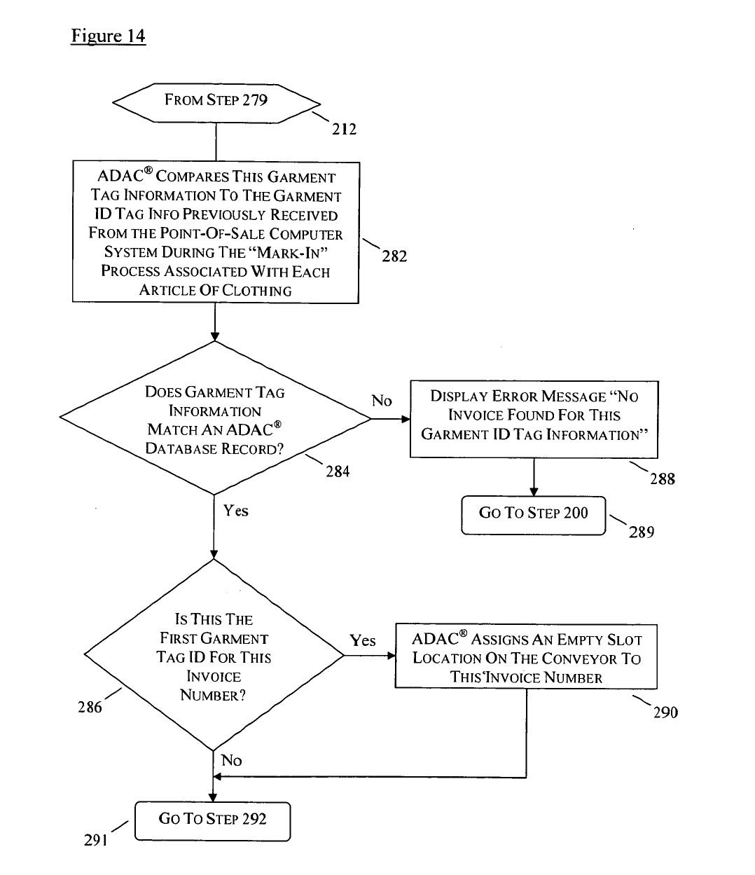

Step 265 (FIG. 12) connects to step 270 (FIG. 13) and thus to step 272, which has several functions. Step 272 passes previously collected tag status information relating to “promised day,” “piece count”, “tag color”, “striped or non-striped”, “tag style” to the software program. Step 274 displays the status information on the touch screen monitor 65 (FIG. 1). If decision step 276 (FIG. 13) finds the information correct, the operator then presses the “accept button” in step 278 and step 279 follows. If the displayed information in step 274 is not correct, the operator corrects missing or invalid information in step 277, which is then followed by step 278, as indicated by line 275.

Steps 210 (FIG. 9) and step 279 (FIG. 13) connect to step 212 at the top of FIG. 14 upon completion. Step 282 that follows compares the garment tag information against the garment ID tag information previously received at the mark in process form the point of sale, which was scanned and stored in the program. Step 284 determines if the garment tag information matches the previously established database record. If so, step 286 follows. If not, step 288 causes the screen display of an error message indicating that no invoice was found for this particular garment ID tag, and step 289 connects back to start step 200 (FIG. 9).

If the garment tag information matches, step 286 (FIG. 14) determines if this is the first garment tag ID for the invoice number. If so, step 290 assigns an empty slot location on the conveyor for the particular invoice number. Step 293 determines if this is the last garment tag ID for the particular invoice number, and, if not, step 302 follows. If this is the last garment ID for the particular order number, step 295 turns on a flashing light on the conveyor to indicate that this invoice or customer number is complete. Step 296 rotates the conveyor to a pre-assigned slot number location for this particular invoice number. In step 297 the operator removes these garments from the conveyor slot location, and a sensor acknowledges that the garments have been removed. Step 299 returns the program to beginning step 200 (FIG. 9).

Step 291 (FIG. 14) connects with step 292 of FIG. 15, which is followed by Step 293, wherein it is determined if this is the last garment tag ID for this invoice. If not, then in step 302 the conveyor is rotated to a pre-assigned slot location for this invoice number. In the succeeding step 304 (FIG. 15) the operator hangs the garment on the pre-assigned conveyor slot and a sensor acknowledges that the garment has been placed there. If this is the last garment to be scanned today, as determined via step 306, the process is ended at 308. If this is not the last garment to be scanned, step 309 gets the next garment to be scanned, and box 311 indicates a repeat of the aforedescribed software process returning to box 200 (FIG. 9). At step 295, the light 140 is activated on the conveyor 105 to indicate that the invoice number is now “complete”. Then at step 296, the conveyor is rotated to the pre-assigned slot location for the specific invoice number above. Next, at step 297, the operator removes all garments from the conveyor slot 150 and the sensor 145 indicates the garments have been removed from the conveyor 105. Once the garments have been removed, the system 20 proceeds back to step 200.

FIG. 16 illustrates the Point-of-Sale System 76, which may operate independently from the system 20 to collect information. The system continuously polls for existing information or uses the Operating Systems file notification service to determine when data is available. Step 400 starts the subroutine. If it is determined in Step 401 that the POS System has provided information by creating a file, the invention will read and parse the file in step 404 and check for errors in step 405. The information can be stored in the local database in a local table in step 406, or an error log entry is made in step 407 describing the error.

Steps 500 and 501 represent the method which the invention provides information to the Point-of-Sale System. Various events that the operator performs create data records to allow the Point-of-Sale System to have real-time status of the garments and orders. Examples of events are racking of a garment, un-racking of a garment, completion of an order and manual removal of an order among other events.

FIG. 17 illustrates the optional mark-in station 78 (“ADAC Plus”), wherein the mark-in station 78 may interface with the Point-of-Sale system 76 or may operate independently. In the preferred embodiment, the mark-in station 78 is utilized in conjunction with the Point-of-Sale system 76. In an alternate embodiment, an individual that does not possess the Point-of-Sale system 76, or that does not have an interface between the mark-in station 78 and the Point-of-Sale system 76, may use the mark-in station 78 in lieu of obtaining the mark-in information (as described above) from the Point-of-Sale system 76. In yet another alternate embodiment, when there is an interface between the Point-of-Sale system 76 and the mark-in station 78, the mark-in station 78 may be utilized for mark-in of some items while the Point-of-Sale system 76 is used for other items. An example would be a dry-cleaner who has a POS system for his retail stores, but also has wholesale customers (i.e. other dry-cleaning drop store operators) who either do not have a POS, or have a different POS than the one he uses. In this case, the POS system would be used for mark-in of the customers' items that are dropped off at his retail locations, while the ADAC Plus system would be used for mark-in of items brought in from his wholesale accounts.

Therefore, with the mark-in station 78, mark-in information goes into the mark-in station 78 database and is then sent to the data processor 70. Subsequent, the data processor 70 sends the print command to the printer (or printers) upon completion of each order during the assembly process. With items marked in through the Point-of-Sale system 76, the information first goes to the POS database, and then is sent to the data processor 70 via the interface. Upon completion of an order, the data processor 70 sends information to the POS via the interface and the POS sends the command to the printer to print the ticket for the order.

First at step 300, the Operator signs in via the touch screen. The ID is compared to the table in the database for validity and access level. At step 305, the Operator presses the “New Ticket” button to begin the mark-in process. At step 310, the Operator changes the due date (or promise time) on the computer to signify when the order needs to be ready, if necessary. Normally most tickets will have the same due time and this step can be skipped once the correct due time has been entered for the session. Then at step 315, the Operator examines whether the store/route has been selected. As such, like the due time referenced above, items are normally marked-in by store/route in batches. Once the operator selects the proper store, this step can be skipped in subsequent ticket mark-ins, as long as the target is the same as the previous marked in order. If this is the first ticket of the programs execution, the software will force the operator to select a store or route at step 320, otherwise control is passed to step 330. At step 320, the software will present the operator with a dialog to pick a predefined Store/Route (Target Destination) from a list. Subsequently, at step 325, the Operator Picks Target Destination from the dialog presented in step 320.

It is important to note each store has its own color assigned to it. Once the store has been selected, the ticket screen on the display changes color to match the store selected. This gives the operator another point of reference to avoid marking in orders for the wrong target. At step 330, the Operator is presented with a dialog box allowing entry of the invoice number from the original invoice being entered. If the invoice contains a machine readable code, the operator would simply scan the invoice using an imager to capture the information. In the event of a non machine readable code, the operator inputs the invoice number through the on screen keyboard. At step 335 the operator physically counts the garments they will be marking in for this invoice and enters the number of items on the invoice. This is used in step 120 to verify that every piece has been entered. At step 340, the Operator using the imager scans the barcode for the garment. If the barcode is not machine readable, the operator may choose the option of an on screen keyboard to enter the garment ID. At step 345, the garment table in the database is checked to see if the unique ID of the garment is on file. If the garment is on file, control is passed to step 350 otherwise control is passed to step 355. At step 350, the customer's name field is populated with name of the customer stored in the database table. At step 355, the total number of pieces the operator indicated they would be marking in step 335 is compared to the total number of pieces entered. If so, control is passed to step 365, otherwise control is passed to step 360.

Again, it is important to note that the Operator may at anytime update the amount of pieces they will be marking in by selecting the piece count button and entering a new amount. This would be used if they found an extra piece, or had miscounted originally. At step 360, the software will disable the “END” button. This prevents the operator from finishing the invoice until the number of items scanned at step 355 matches the number of items operator will be entering at step 335. At step 365, the software will enable the “END” button so the operator can finish the invoice. At step 370, if the operator presses the “END” button control continues on to step 370, otherwise control is passed back to step 340 allowing a new garment to be entered. At step 375, the Operator is presented with a dialog box to enter the customer's name. If a customer was identified in step 345, the Operator will be presented with that name and may just accept the customer. If the customer's name does not match the customers name on the original invoice, they may simply overwrite the name with the correct information. Lastly at step 380, the system will save the transaction in the database and flag it for transmission to the data processor 70.

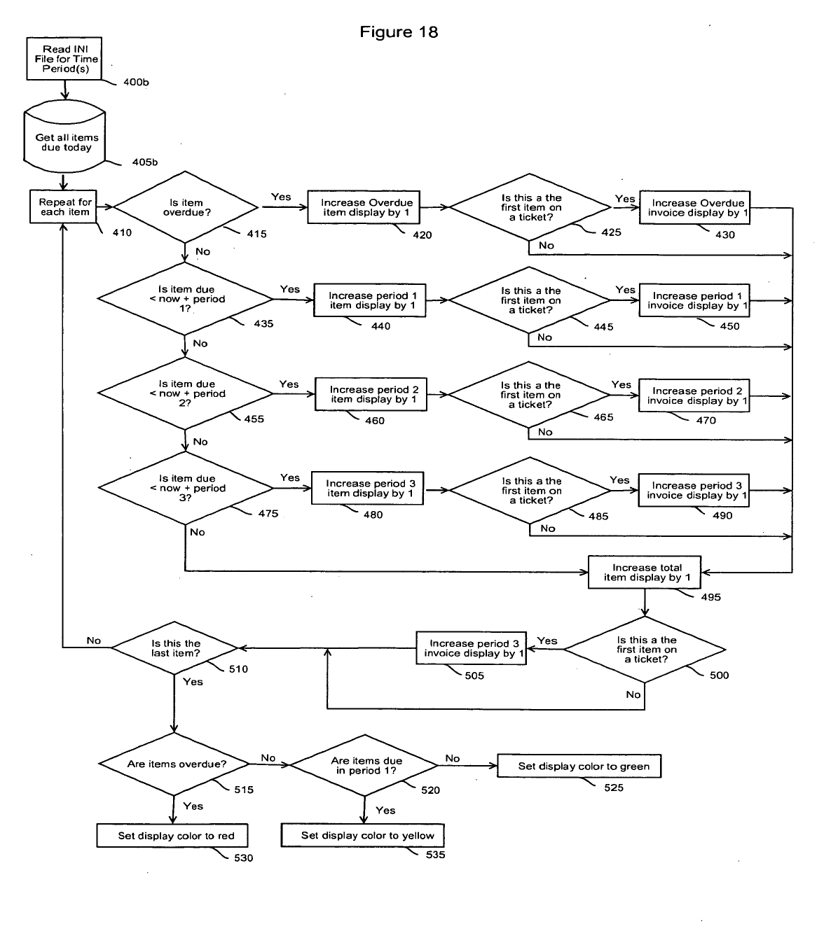

FIG. 18 illustrates the time specials feature of the system 20 that allows for the operator to provide a display of garments coming due at user defined intervals. For example, occasionally a dry cleaner's customer will need a garment before the normal due time (i.e. normally the clothes are promised for 5:00 pm, but this customer needs his by 2:00 pm to make a flight). The present system 20 will display to the operator that a garment is coming due within the specified time frame. The default times are End of Day, 2 hours, 1 hour, 30 minutes, and past due. Each threshold has its own box to display the number of items/orders due within that time frame. When all the orders are due in 30 minutes or more, the display shows number of pieces and orders, and has a green back ground. When an order is due in less than 30 minutes (or smallest user defined time frame) the displays are now a yellow back ground to alert the operator. Once an item has gone over due, the display turns red. The operator may, at anytime touch the buttons on the screen to see a list of the items due.

At step 400B, the ini, or settings, file for the program is read. The end user may define three time periods to display. By default these time periods are:

Period 1: 30 Minutes

Period 2: 60 Minutes

Period 3: 120 Minutes

For the purpose of clarity, applicant will refer to each of these periods with the default time periods throughout the remainder of this figure.

At step 405B, the database is queried for all items that are due out today. These items are then collected as a record set and examined in subsequent steps. At step 410, the records that were collected by step 405 are cycled through one by one. At step 415, the due time of the item is compared to the current clock time. If the item was due to be finished prior to now, control continues to step 420. Otherwise control is passed to step 435. At step 420, the on screen counter is incremented by 1 to show an increase in the overdue items. At step 425, the display also shows, in addition to how many items are due, the number of tickets due. If this is the first item then control continues to step 430, otherwise control is passed to step 495. At step 430, the display that shows the number of invoices overdue is increased by one; control is passed to step 495.

At step 435, it is determined whether there is an item due in less than thirty minutes from now. If yes, then control continues to step 440, otherwise control is passed to step 455. At step 440, the on screen counter is incremented by 1. At step 445, if this is the first item then control continues to step 450, otherwise control is passed to step 495. At step 450, the display that shows the number of invoices due in thirty minutes is increased by one; control is passed to step 495. At step 455, it is determined whether there is an item due in less than sixty minutes from now? If yes, then control continues to step 460, otherwise control is passed to step 475. At step 460, the on screen counter is incremented by 1. At step 465, if this is the first item then control continues to step 470, otherwise control is passed to step 495. At step 470, the display that shows the number of invoices due in sixty minutes is increased by one; control is passed to step 495. At step 475, it is determined whether there is item due in less than one hundred twenty minutes from now? If yes, then control continues to step 480, otherwise control is passed to step 495. At step 480, the on screen counter is incremented by 1. At step 485, if this is the first item, then control continues to step 490, otherwise control is passed to step 495. At step 490, the display that shows the number of invoices due in one hundred twenty minutes is increased by one; control is continues to step 495.

At step 495, the display that contains the total items due by the end of the day is updated. This display is inclusive of all other time periods. At step 500, if this is the first item then control continues to step 505, otherwise control is passed to step 510. At step 505, the display that shows the number of invoices due for today is increased by one; control is continues to step 510. At step 510, this checks to see if this is the last item of the record set created in step 405. If it is control continues to step 515, otherwise control is passed to step 415 for the next record. At step 515, if overdue items exist then control is passed to step 530, otherwise control continues on to step 520. At step 520, if items are due in less than thirty minutes, control is passed to step 535, otherwise control continues to step 525. At step 525, if no items are due in thirty minutes or overdue, then the operator's display is set to green. At step 530, if items are overdue, the operator's display is set to red. This alerts the operator that they are overdue and need to take action. Finally, at step 535, if items are due in less than 30 minutes, then the operators display is set to yellow. This warns the operator that they have items due shortly and need to take action before the items become overdue.

In addition to the above disclosed system 20, there are additional embodiments and options shown below to assist the operator in efficiency and use of the overall system 20.

### Missing Items Report:

This prints a report for the operator that shows items that have yet to be assembled. This report may also be run specified for the time periods specified in the time special thresholds. The printed report gives the operator the information needed to track down the garments in the plant. It also provides a space for the operator to make notes on if they found it, it is missing, or if it is being held and the reason why it is being held.

### Loaded Items History Report:

This report shows the history of an item. It also shows the history of the items that were hung next to it, offloaded before and after it. In the rare case where an operator may have mixed up pieces while packing the completed order, this gives them a report to track down where the pieces may have gone.

### Voice Prompts/Confirmations:

The system 20 may use verbal prompting to supplement the visual displays. In one embodiment, a pair of sound effects as audio cues may be utilized. The first is a “ding” subtle bell sound, which repeats after an item is scanned until it is confirmed to have been racked (through the sensor or screen press). The second is a more pronounced Chime or Harp sound, this plays once an order is complete until the order is removed. Voices are generated through Microsoft's Speech Application Programming Interface (SAPI). Thus, by utilizing the SAPI process we can create customer specific prompts at run time. For example:

When an item is scanned:
a. On a single piece order, the SAPI voice will announce “this is a single piece order, order complete . . . ” and the Chime will repeat until the item is removed
b. On the first piece of a multi piece order, the SAPI voice will announce “Please hang the garment on hook 24.” The ding sound will repeat until the rack operation is completed.
c. On subsequent pieces of multi piece orders the SAPI voice will announce “Please hang the garment on hook 24 with the 2 other pieces” Obviously hook number and number of pieces changes to reflect the current and correct information. The ding sound will repeat until the rack operation is complete.
d. On the final piece of multi piece orders the SAPI voice will announce “Order Complete. Please remove the 4 piece order from slot 24”. The chime sound will repeat until the order is removed.

### Multi-Language:

One of the benefits of using a SAPI based system is the ability to send custom text at run time and have it read to the operator. SAPI voices come from numerous third party software providers in different languages and genders. Simply by installing another language SAPI voice and sending it the correct prompts in that language it is read out load.

While several embodiments of the instant invention have been illustrated by way of example, it is apparent that further embodiments could be developed within the spirit and scope of the instant invention. However, it is to be expressly understood that such modifications and adaptations are within the spirit and scope of the instant invention, as set forth in the following claims.

I claim:

1. A system for assembling and sorting items comprising:
an intake system, wherein the intake system comprises a plurality of items organized as a group;
an input system, wherein the input system is disposed to allow input of the information located on an item into a database; and
an assembly system, wherein the assembly system is disposed to locate and position a selected item within relative proximity to other items within the same group.

2. The system of claim 1, wherein the information located on an item is contained within an identification tag.

3. The system of claim 1, wherein the input system further comprises a scanning device disposed to interpret the information located on each item.

4. The system of claim 1, wherein the scanning device is selected from the group consisting of an optical character recognition scanner, a bar code scanner and a radio frequency/radio frequency identification receiver.

5. The system of claim 1, wherein a component for the input of information into the data processor is selected from the group consisting of a keyboard, mouse, touch screen monitor and a point-of-sale system.

6. The system of claim 1, wherein the assembly system further comprises:
an assembly conveyor, wherein the assembly conveyor comprises a plurality of conveyors slots disposed to hold a plurality of items;
a conveyor control unit, wherein the conveyor control unit is in data communication with the database via a communication interface; and
a loading shroud assembly.

7. The system of claim 6, wherein the loading shroud assembly further comprises:
a loading shroud;
a light, wherein the light is disposed to illuminate when a plurality of items are designated to be removed from the assembly system;
a sensor, wherein the sensor is in electrical and electronic communication with the conveyor control unit to indicate when the plurality of items are removed from the assembly system;
an emergency stop switch; and
a manual jog switch, wherein the manual jog switch is disposed to allow an operator to move the assembly conveyor manually.

8. The system of claim 7, wherein the assembly system further includes a conveyor slot bracket containing a plurality of beam sensors disposed to create a digital pattern when one slot passes through the bracket, and disposed to ascertain the position of the conveyor assembly.

9. The system of claim 5, further comprising a mark-in station to input the information located on the item into the database.

10. The system of claim 1, wherein the system further comprises a time specifying feature that allows for a display of garments coming due at user defined intervals.

11. The system of claim 1, wherein the system is disposed to be utilized in the dry cleaning industry to interpret and process various tags and labels in the classification and sorting of a plurality of items for cleaning.

12. A method of sorting and assembling a plurality of items utilizing the apparatus of claim 1, comprising the steps of:
receiving a plurality of items from a customer through a “mark-in” process;
interpreting an identification tag located on each item;
inputting all information located within the identification tag into a data processor;
assigning a conveyor slot to each item based on the information located within the identification tag of the item; and
placing each item onto the conveyor slot assigned based on the information located within the identification tag of the item.

13. The method of claim 12, wherein the “mark-in” process further comprises the steps of:
assembling a plurality of items belonging to a given customer transaction into a group; and
repeating the assembly process if the same customer brings in separate items over multiple visits.

14. The method of claim 12, wherein interpreting the identification tag located on each item further comprises the steps of:
scanning the information located within the identification tag of each item;
generating an internal binary text string from the information located within the identification tag of each item; and
comparing the binary text strings generated from scanning each item to either various text strings stored in an inventory management system database, or to various text strings stored in an internal lookup table, to identify the group an item belongs to.

15. The method of claim 12, wherein inputting the information located within the identification tag of each item is accomplished through a point-of-sale system.

16. The method of claim 12, wherein inputting the information located within the identification tag of each item is accomplished through a mark-in station.

17. The method of claim 16, wherein the process of utilizing the mark-in station further comprises the steps of:
signing into the system by an operator via a touch screen;
selecting a new ticket;
selecting a date and time for an order to be completed;
selecting a store for the order;
selecting a delivery route;
scanning an original invoice number;
entering the number of items contained within the invoice;
scanning the identification tag located within each item;
determining whether the identification tag is on file with the database;
checking whether the total items scanned equals the total number of items entered;
enabling an end button; and
saving the transaction to the database.

18. The method of claim 12, wherein assigning a conveyor slot further comprises the steps of:
assigning a conveyor slot on a conveyor for an item that is contained within a group;
determining if the conveyor has any empty odd-numbered slots, and wherein when the conveyor has any empty odd-numbered slots, then;
selecting the empty, odd-numbered slot that is nearest to the current position at the loading shroud opening, and wherein when the odd-numbered slot is not selected, then;
selecting the empty, even-numbered slot that is nearest to the current position at the loading shroud opening;
storing the assigned slot information for the given group order in a database;
retrieving the assigned slot information for the given item's group order; and
rotating the conveyor in the direction that will yield the shortest travel distance until the slot assigned to the given group order above is positioned at the loading shroud opening.
